(19) United States
(12) Patent Application Publication
(10) Pub. No.: US 2002/0171875 A1
(43) Pub. Date: Nov. 21, 2002

(54) Facsimile apparatus, method of controlling facsimile apparatus, and program of controlling facsimile apparatus

(76) Inventor: Takehiro Yoshida, Tokyo (JP)

Correspondence Address: FITZPATRICK CELLA HARPER & SCINTO, 30 ROCKEFELLER PLAZA, NEW YORK, NY, 10112, US

(21) Appl. No.: 10/127,589

(22) Filed: Apr. 23, 2002

(30) Foreign Application Priority Data
Apr. 25, 2001 (JP) 126878/2001(PAT.)

(51) Int. Cl. B41J 1/00; H04N 1/00

(52) U.S. Cl. 358/400

(57) ABSTRACT

It is made feasible to transmit images of single-side/dual-side mixed originals without degradation of communication compatibility and transmit the images with natural originator information while avoiding making an odd impression on a receiving user. Under control of CPU 22, detection is made to detect whether image information of a back side (or a front side) of an original read by reading circuit 14 is entire-blank image information of an almost entire-blank. When the entire-blank image information is detected, the entire-blank image information is transmitted based on ITU-T Recommendation T.30, but it is transmitted without adding originator information to the entire-blank image information. A page number included in the originator information is not counted up with the entire-blank image information, but is counted up with effective image information being not entire-blank and provided with the originator information. Therefore, the originator information with page numbers of serial numbers is generated for only the effective image information being not entire-blank.

### BACKGROUND OF THE INVENTION

1. Field of the Invention

The present invention relates to facsimile apparatus for transmitting dual-side image information, a method of controlling the same, and a program of controlling the same.

2. Related Background Art

The conventional facsimile apparatus was constructed on the basis of the operation of transmitting an original with single-side information and recording the information on a single side of a sheet. Conventional ITU-T Recommendations T4, T30, and so on described only the single-side communication.

On the other hand, there is recently growing awareness about resource savings, and printers, copying machines, etc. are on their way to increase in the number of those equipped with the so-called dual-side recording method of recording information on the both front side and back side of each sheet. Under such circumstances, the standards concerning the dual-side facsimile communication were made as ITU-T Recommendation in February, 2000.

New ITU-T Recommendation T.30, or its draft proposal defines, as transmission methods of dual-side image information, methods including dual-side alternate transmission (alternate mode) of alternately transmitting an image on the front side and an image on the back side of an original page by page, and dual-side continuous transmission (continuous mode) of first transmitting all images on front sides of originals and thereafter transmitting all images on back sides of the originals.

The dual-side communication in new ITU-T Recommendation T.30, or its draft proposal is based on the premise that every original is a dual-side original, i.e., that the both sides of every original always include significant images. In such dual-side communication, even in the case where there are dual-side originals and single-side originals (e.g., originals with entire-blank information on their back side) mixed, the apparatus must execute the phase of transmitting the back-side information of each single-side original (intermediate procedure and transmission procedure of entire-blank image).

Meanwhile, there is the conventionally known technology of recording originator (calling station) information at the receiver end. This originator information is generated as an image including a communication date & time, an originator's identification number (telephone number, mail address, etc.), an originator's name (or an arbitrary character string defined by the user, or the like), a page number, etc. by the use of a character generator or the like (this image data generation is often executed at the transmitter end), and it is recorded at a head portion of each recording sheet or the like. The originator information is sometimes called header information or the like because of its recording position.

When consideration is given to both the recoding of the originator information and the specification of foregoing ITU-T Recommendation T.30 that transmission must be carried out even for a formally entire-blank side in the case of a single-side original, the specification has to be such that the originator information is recorded on a recording sheet even if the corresponding side of the original is entire-blank. However, even though it is natural in terms of the specification, there arises a problem that the originator information recorded even on the blank surface makes an odd impression on the receiving user.

### SUMMARY OF THE INVENTION

An object of the present invention is to enable transmission of images of single-side/dual-side mixed originals without degrading communication compatibility and also enable transmission of images of single-side/dual-side mixed originals while providing natural originator information without making the odd impression on the receiving user.

It is an object of the present invention to provide a facsimile apparatus for transmitting dual-side image information, comprising detecting means for detecting whether image information of a front side or a back side of an original to be transmitted is entire-blank image information being almost entire-blank, and control means for performing such control that, when said detecting means detects the entire-blank image information, the entire-blank image information is transmitted, without adding image information of corresponding originator information to the entire-blank image information.

It is another object of the present invention to provide a control method for a facsimile apparatus capable of transmitting dual-side image information, comprising the steps of detecting whether image information of a front side or a back side of an original to be transmitted is entire-blank image information being almost entire-blank, and performing such control that, when said detecting step detects the entire-blank image information, the entire-blank image information is transmitted, without adding image information of corresponding originator information to the entire-blank image information.

It is still another object of the present invention to provide a storage medium storing a program for executing a control method for a facsimile apparatus capable of transmitting dual-side image information, said control method comprising the steps of detecting means for detecting whether image information of a front side or a back side of an original to be transmitted is entire-blank image information being almost entire-blank, and performing such control that, when said detecting step detects the entire-blank image information, the entire-blank image information is transmitted, without adding image information of corresponding originator information to the entire-blank image information.

### BRIEF DESCRIPTION OF THE DRAWINGS

FIG. 1 is a block diagram showing the hardware structure of a facsimile apparatus to which the present invention is applied;

FIG. 2 is a table showing FIFs of DIS/DTC and DCS signals used in the dual-side transmission of the present invention;

FIG. 3 is a schematic diagram showing the format of a post-message signal used in the dual-side transmission of the present invention;

FIG. 4 is a schematic diagram showing the procedure of dual-side communication in the alternate mode in the non-ECM communication mode;

FIG. 5 is a schematic diagram showing the procedure of dual-side communication in the alternate mode in the ECM communication mode;

FIG. 6 is a schematic diagram showing the procedure of dual-side communication in the continuous mode in the non-ECM communication mode;

FIG. 7 is a schematic diagram showing the procedure of dual-side communication in the continuous mode in the ECM communication mode;

FIG. 8 is a flowchart showing the communication control executed by CPU 22 of FIG. 1;

FIG. 9 is a flowchart showing the communication control executed by CPU 22 of FIG. 1;

FIG. 10 is a flowchart showing the communication control executed by CPU 22 of FIG. 1;

FIG. 11 is a flowchart showing the communication control executed by CPU 22 of FIG. 1;

FIG. 12 is a flowchart showing the communication control executed by CPU 22 of FIG. 1;

FIG. 13 is a flowchart showing the communication control executed by CPU 22 of FIG. 1;

FIG. 14 is a schematic diagram showing configurations of images of originals transmitted according to the present invention; and

FIG. 15 is a flowchart showing different communication control carried out by CPU 22 of FIG. 1.

### DESCRIPTION OF THE PREFERRED EMBODIMENTS

Embodiments of the present invention will be described below with reference to the drawings.

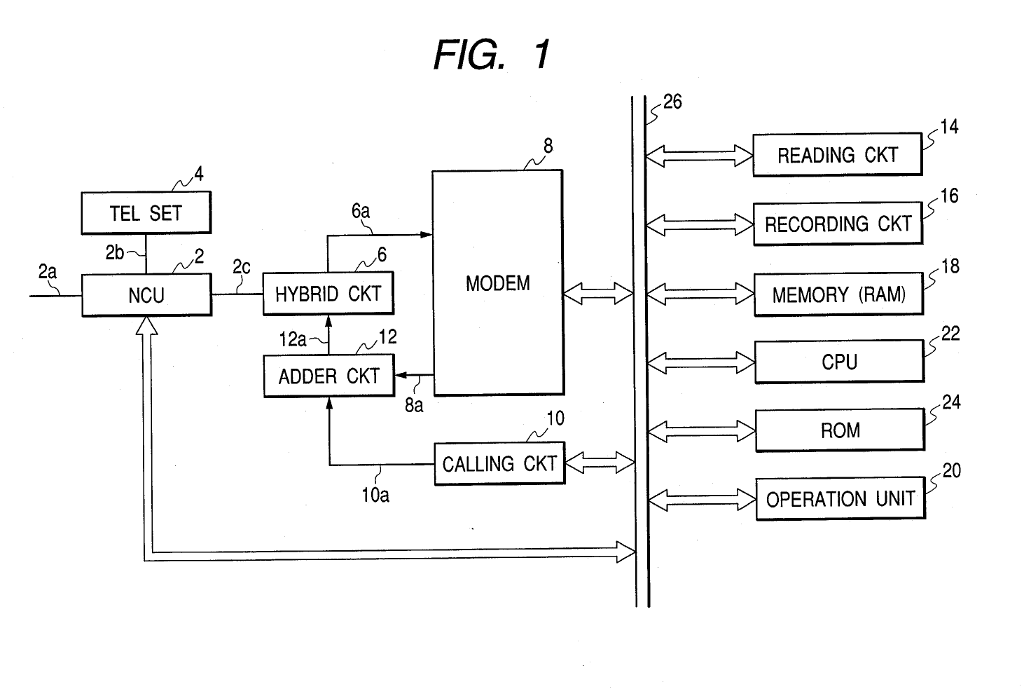

FIG. 1 shows the hardware structure of a facsimile apparatus to which the present invention is applied. In FIG. 1 reference numeral 2 designates an NCU (network control unit), which is connected with a terminal on a communication line in order to use a telephone network for data communication and others, controls connection to a telephone switching network, performs switching to a data communication line, and holds a loop. The NCU 2 connects the telephone line 2a to a telephone set 4 (CML off) or to the facsimile apparatus (CML on) according to control through a bus 26. In the normal state the telephone line 2a is connected to the telephone set 4.

Numeral 6 denotes a hybrid circuit, which separates transmitting signals and received signals, sends the transmitting signals from an adder circuit 12 via the NCU 2 onto the telephone line 2a, receives signals from a correspondent via the NCU 2, and feeds the received signals through a signal line 6a to a modem 8.

Numeral 8 represents a modem, which performs modulation and demodulation based on ITU-T Recommendations V. 8, V. 21, V. 27ter, V. 29, V. 17, and V. 34. The modem 8 inputs a transmitting signal through the bus 26, outputs modulated data onto a signal line 8a, inputs a received signal fed through the signal line 6a, and outputs demodulated data onto the bus 26. Each of the foregoing transmission modes used in the respective operations is designated through the bus 26.

Numeral 10 designates a calling circuit, which inputs telephone number information and outputs a select signal of the DTMF format onto a signal line 10a according to control through the bus 26.

Numeral 12 indicates an adder circuit, which inputs information through the signal line 8a and information through the signal line 10a and outputs the result of addition onto a signal line 12a.

Numeral 14 designates a reading circuit capable of reading image information from the both sides of each original, which consists of an optical reading device and an original conveying system and which outputs read data onto the bus 26. The present embodiment is based on the premise that the original conveying system of the reading circuit 14 is constructed to effect reading of information from the both sides of originals in the following order: the front and back sides of the first original, the front and back sides of the second original, . . . , while reversing each original from the front side to the back side.

Numeral 16 denotes a recording circuit capable of recording dual-side information, which sequentially records the information fed through the bus 26, line by line. The recording circuit 16 is equipped with a recording mechanism such as a laser beam printer or the like and is configured to effect recording of images on the both sides of each recording sheet by the use of a recording sheet reversing mechanism (not shown) or the like.

Numeral 18 represents a memory circuit, which incorporates a RAM (or a read-writable memory such as a hard disk drive or the like) and which is used as a work area of CPU 22 described hereinafter. The memory circuit 18 stores read or received image data in the form of raw data or coded data, and also stores other control data. Access to the memory circuit 18 is made through the bus 26.

Numeral 20 indicates an operation unit, which includes one-touch dialing keys, abbreviated dialing keys, ten keys, a * key, a # key, a start key, a stop key, a set key, a dual-side transmission select key, and other function keys, and which outputs operation information on these keys onto the bus 26. The operation unit 20 is provided with a display unit consisting of a display device such as an LCD or the like, which is used for monitoring the operation condition of the apparatus and as a user interface for various settings. Access to the operation unit 20 is made through the bus 26.

Numeral 22 denotes a CPU (central processing unit), which controls the. total operation of the facsimile apparatus and executes the facsimile transmission control procedure. Control programs of the CPU 22 are stored in ROM 24. Numeral 26 designates the bus of the CPU 22, which is composed of an address bus and a data bus.

In the present embodiment, the facsimile communication as described below is carried out under control of the CPU 22.

(1) When a certain original surface (a back side in the control examples below) is entire-blank, the entire-blank information of the back side is transmitted according to ITU-T Recommendation T.30.

(2) A page number (PN described hereinafter) and front/back identification information (SIDE described hereinafter) specified by ITU-T Recommendation are also transmitted according to ITU-T Recommendation T.30.

(3) When the entire-blank information is transmitted as image information of a certain original surface (a back side in the control examples below), control is made so that the originator information (header information) is not recorded for that side at the receiver end.

(3′) As for page numbers recorded as the originator information on the receiver end, the number of pages is counted up with effective image information being not entire-blank, but is not counted up with entire-blank information.

For example, let us suppose that three originals in respective configurations as described below are transmitted:

first original: single-side information (with the back side being entire-blank)

second original: dual-side information

third original: single-side information (with the back side being entire-blank).

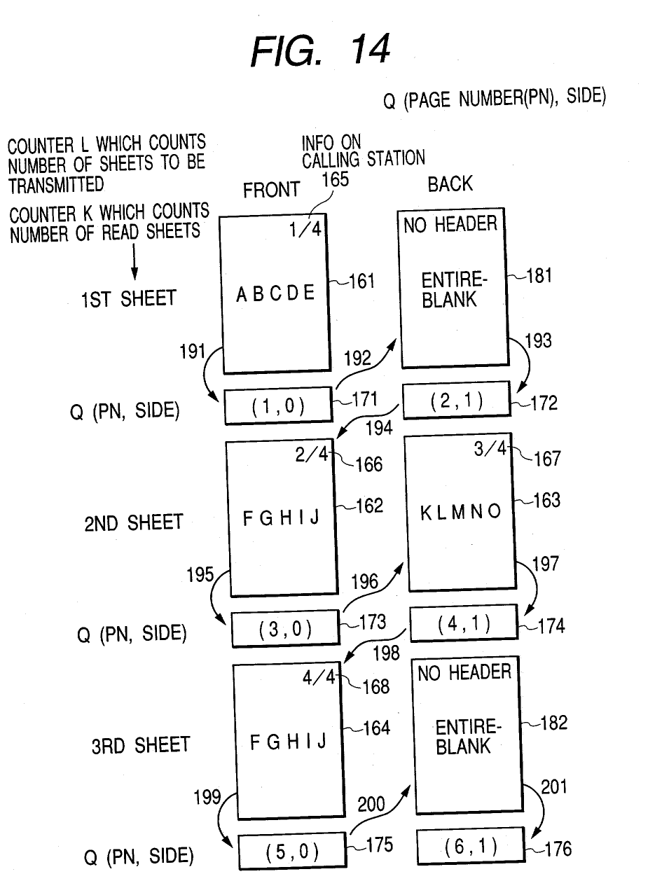

In the present embodiment the information is transmitted as shown in FIG. 14.

In FIG. 14 numerals 161 to 164 designate image data of four sides being not entire-blank, and originator information pieces 165 to 168 are added in the form of “page number/total page number” to the head part of the respective image data 161 to 164. The total page number represents the number of effective images, which is 4 in the case of FIG. 14. In the form of “page number/total page number” of the originator information, the denominator part of “/total page number” is optional information and does not always have to be generated and transmitted.

Numerals 171 to 176 indicate post-message signals (so called Q signals) described hereinafter, each of which provides two digits, a page number (PN described hereinafter) and front/back information (SIDE described hereinafter) from the left in parentheses.

Among these, the page number (PN) and the front/back information (SIDE) are those specified in ITU-T Recommendation T.30. The page number (PN) is incremented first for the front side and then for the back side, and the front sides are always odd numbers. The front/back information is expressed by the digits of front: 0 and back: 1.

Numerals 181, 182 denote entire-blank image data transmitted as a back side, because the first and third originals are single-side originals. In the present embodiment, no originator information is added to these entire-blank image data 181, 182.

The image data 161 to 164, the entire-blank image data 181, 182, and the respectively corresponding post-message signals 171 to 176 are transmitted in the order indicated by arrows 191 to 201.

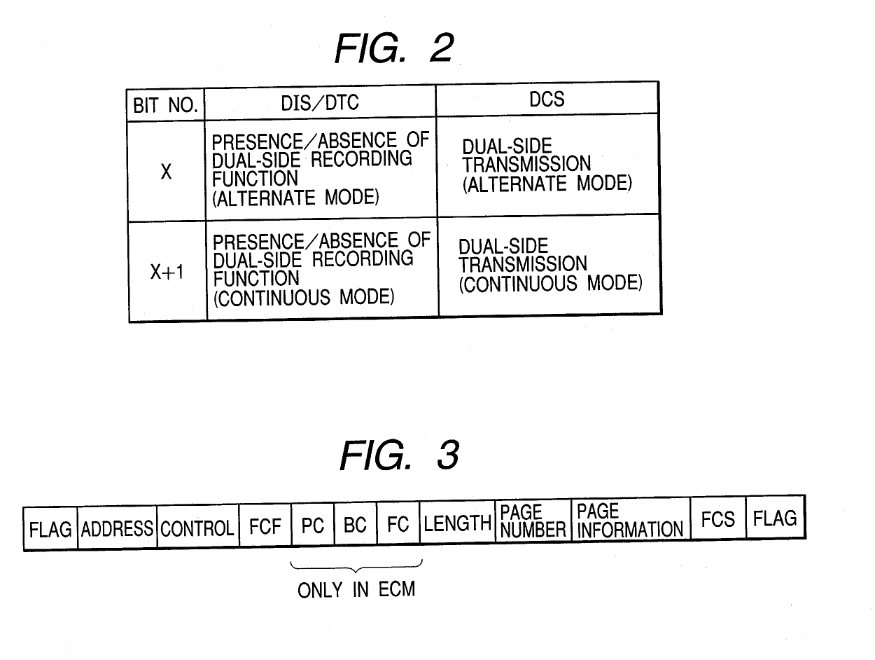

The following will schematically describe the communication procedures for-the dual-side transmission in the present embodiment, with reference to FIGS. 2 to 7. The portions shown in FIGS. 2 to 7 are substantially the same as the procedures based on ITU-T Recommendation T.30.

As the communication modes of dual-side transmission defined in ITU-T Recommendation T.30, there are two modes, an alternate mode (dual-side alternate transmission mode) and a continuous mode (dual-side continuous transmission mode). The former is a mode of alternately transmitting the front side and back side of each original, i.e., the front side and back side of the first original, the front side and back side of the second original, and so on. The latter is a mode of first transmitting only the front sides of all the originals in the ascending page order, i.e., the front side of the first original, the front side of the second original, . . . , and thereafter transmitting the back sides of all the originals in the ascending page order, i.e., the back side of the first original, the back side of the second original, and so on. The facsimile apparatus can use either of the modes according to its implementation form.

Next, FIG. 2 shows a table of configurations of information designating the dual-side transmission in FIFs (facsimile information fields) of respective signals of DIS (digital identification signal: transmitted from the image receiving terminal), DTC (digital transmission command: transmitted from the image transmitting terminal), and DCS (digital command signal: transmitted from the image transmitting terminal).

In the DIS/DTC signal, as shown in FIG. 2, the bit x (in fact, the 113th bit though the figure indicates the bit number by “x”) of FIF indicates presence/absence of the dual-side recording function in the alternate mode, and the bit (x+1) (in fact, the 114th bit) of FIF does presence/absence of the dual-side recording function in the continuous mode. In the DCS signal, the bit x (113th) bit of FIF designates the dual-side transmission in the alternate mode, and the bit (x+1) (114th) bit of FIF the dual-side transmission in the continuous mode.

FIG. 3 shows a frame configuration of a Q signal (specifically, a signal such as EOP (end of page), MPS (multi page signal), EOM (end of message), or the like) in normal G3 transmission and a PPS-Q signal (specifically, a post-message signal such as PPS-EOP, PPS-MPS, PPS-EOM, PPS-NULL, or the like) in ECM (error correction mode) transmission.

In these post-message signals, as shown in FIG. 3, the facsimile information is transmitted subsequent to Flag (flag), Address (address), Control (control data), and FCF (facsimile control field). At the head of the facsimile information, three fields of PC (page counter), BC (block counter), and FC (frame counter) are transmitted only in the case of ECM, and the facsimile information associated with the dual-side transmission follows thereafter. As the facsimile information associated with the dual-side transmission, there are Length (the total octet number of subsequent Page number (2 octets) and Page information (1 octet at present)), Page number (page number: 2 octets), and Page information (page information) arranged in the order named, and FCS (frame check sequence) and Flag (flag) follow thereafter.

Among the above, Page number (page number: also referred to as PN) is defined by the rules so as to be counted up from P1 page by page for each of the front and back sides in transmission of the front and back sides of dual-side originals in the page order. Page information (page information) indicates whether the image information of that side is front or back, with the data length of one octet; whether the front side (0) or the back side (1) is expressed by bit 0. Presently, bits 1 to 6 are reserved and their functions are not defined yet, and bit 7 is always set to 0 as an extension bit.

Among the above facsimile information of the post-message signals, the three fields composed of Length, Page number, and Page information are fields that were not defined in the conventional single-side protocols.

The Q signal used in the normal G3 communication does not include PC, BC, and FC, and these are used only in the PPS-Q signal used in the ECM communication.

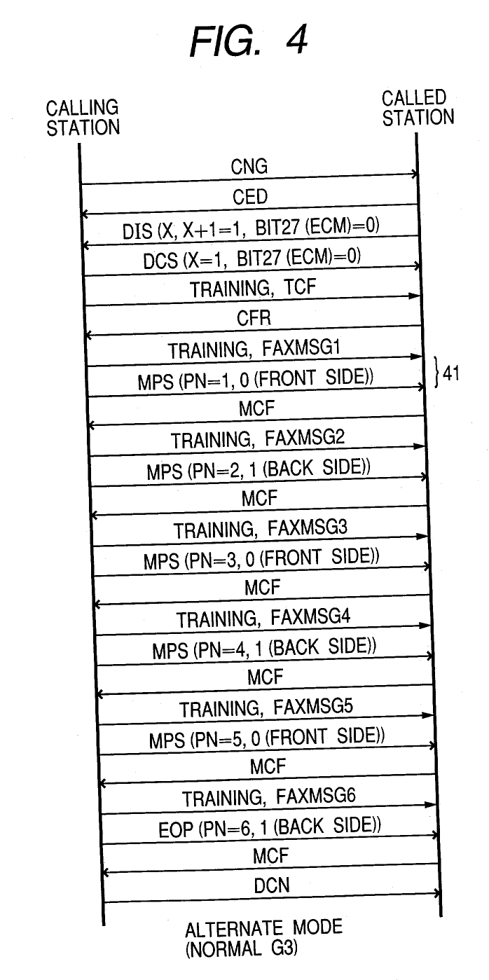

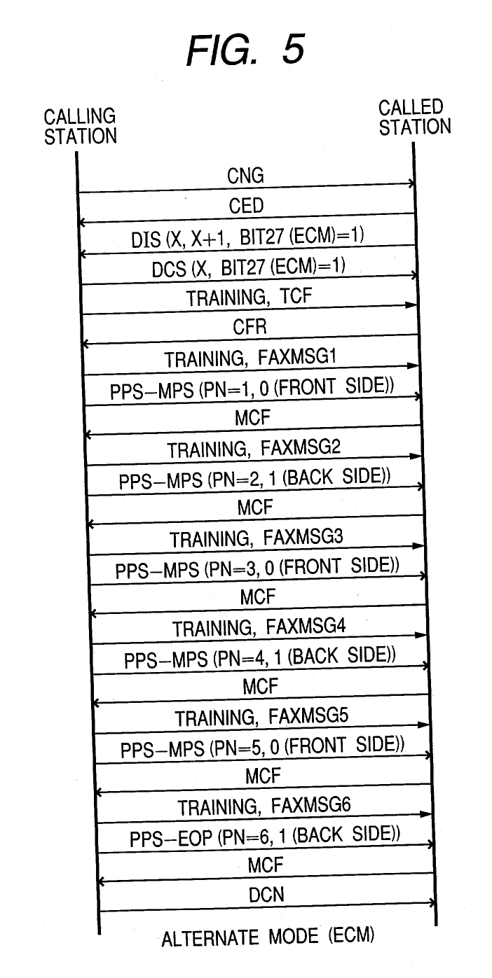

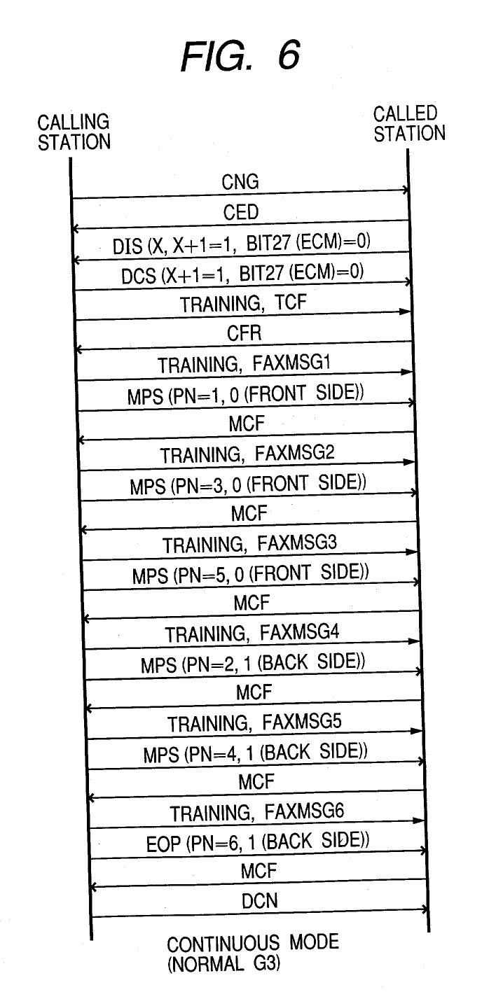

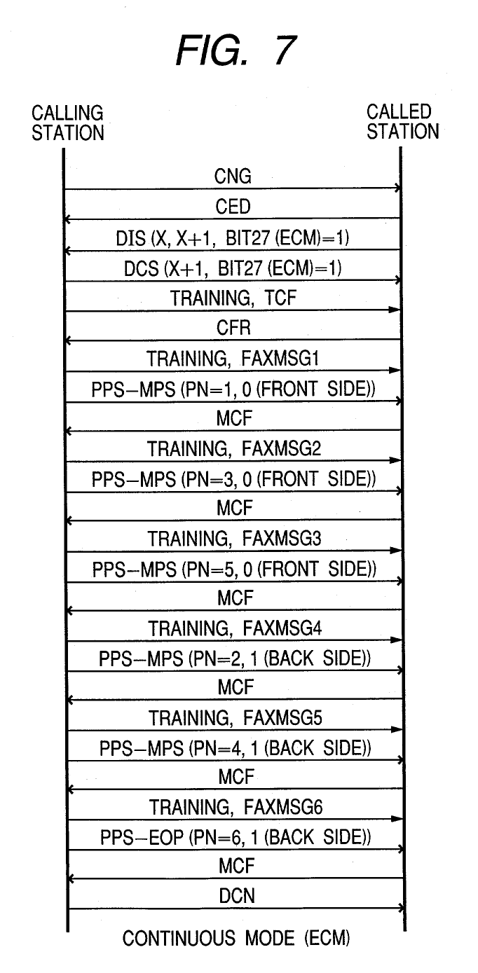

FIG. 4 shows the procedure of dual-side transmission in the alternate mode in the normal G3 mode, FIG. 5 the procedure of dual-side transmission in the alternate mode in the ECM communication mode, FIG. 6 the procedure of dual-side transmission in the continuous mode in the normal G3 mode, and FIG. 7 the procedure of dual-side transmission in the continuous mode in the ECM communication mode.

As shown in FIGS. 4 to 7, the bits x and (x+1) of the DIS signal indicate the dual-side transmission function of the receiver (which supports both the alternate mode and the continuous mode), and the bits x and (x+1) of the DCS signal indicate the dual-side transmission mode declared as a mode to be executed hereafter by the transmitter. In the continuous mode shown in FIGS. 6 and 7, transmission in the continuous mode is declared by setting the bit (x+1) of the DCS signal to 1.

The MPS signals are used as post-message signals in the normal mode, as shown in FIGS. 4 and 6, and the PPS-MPS signals as post-message signals in the ECM, as shown in FIGS. 5 and 7.

In these examples three dual-side originals are transmitted and “PN” in each figure indicates the aforementioned Page Number.

For example, the MPS signal indicated by numeral 41 in FIG. 4 (alternate mode) is depicted as “MPS (PN=1, 0 (front side)),” which means that image information of the page number 1 (PN=1) and the front side (0 (front side)) has been transmitted (the notation of the MPS or PPS-MPS signal in the figures after FIG. 4 is the same as the above).

Namely, in the alternate mode in FIGS. 4 and 5, the image information of the originals is transmitted in the following order: the front side (0) of the first original (PN=1); the back side (1) of the first original (PN=2); the front side (0) of the second original (PN=3); the back side (1) of the second original (PN=4); the front side (0) of the third original (PN=5); and the back side (1) of the third original (PN=6).

In the continuous mode in FIGS. 6 and 7, the image information of the originals is transmitted in the following order: the front side (0) of the first original (PN=1); the front side (0) of the second original (PN=3); the front side (0) of the third original (PN=5); the back side (1) of the first original (PN=2); the back side (1) of the second original (PN=4); and the back side (1) of the third original (PN=6).

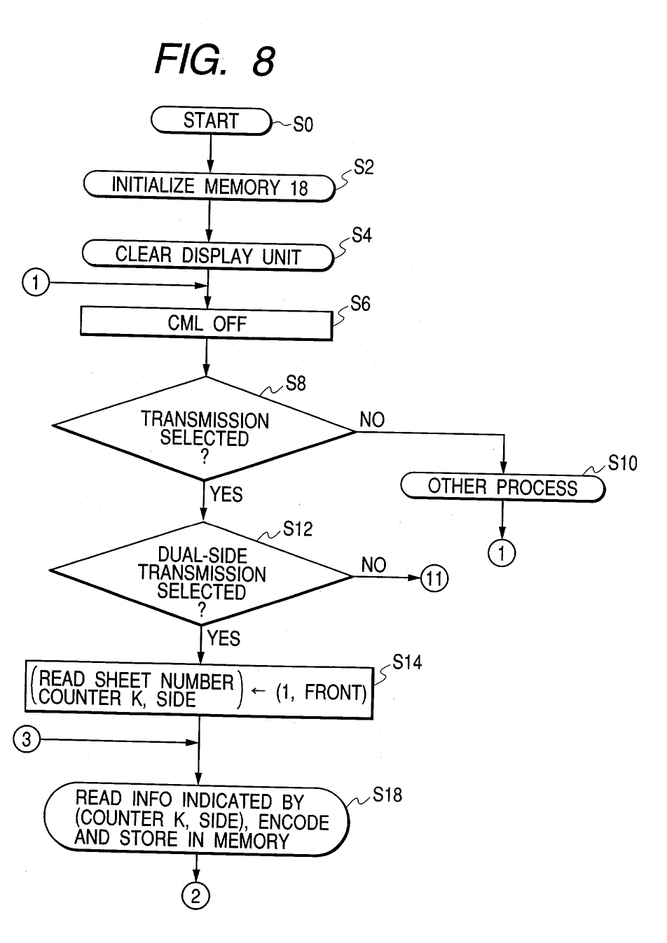

The following will describe the communication control to be executed by the CPU 22 in order to perform the facsimile communication of the present embodiment, with reference to FIGS. 8 to 13. The control procedure of FIGS. 8 to 13 is stored as a program of the CPU 22 in the ROM 24. FIGS. 8 to 13 are flowcharts showing the flow of processing for implementing the aforementioned communication control, in which portions indicated by the same numerals in FIGS. 8 to 13 indicate continuation of processing at respective positions.

In the communication procedure of the present embodiment, when images of single-side/dual-side mixed originals are transmitted and received, the transmitter reads the entire-blank image data from each original side according to ITU-T Recommendation T.30, but the transmitter transmits the entire-blank image data to the receiver, without adding the originator information to the entire-blank image data. On the other hand, for the image data except for the entire-blank data, the originator information is generated as an image and is added to the original image.

In the case of the single-side/dual-side mixed original images, the page numbers included in the originator information are different from the page numbers (PNs) transmitted by PPS-Q. The originator information is not transmitted for entire-blank page and the page number to be included in the originator information is not counted up with that entire-blank page. In contrast with it, the page number (PN) to be transmitted by PPS-Q is counted up even with entire-blank page according to the Recommendation.

In the embodiment described below, whether the entire-blank information or not shall be determined only for the back side information and only the alternate mode will be exemplified as the dual-side communication procedure.

The following will omit the description about the ECM control, but whether or not the ECM communication is performed shall be determined by negotiation using the DIS/DCS signal, as before.

In FIG. 8, step S0 indicates a start of processing to be initiated by a predetermined reset operation or the like.

Step S2 is a step of initializing the memory circuit 18 through the bus 26, and step S4 a step of initializing (or clearing) the display unit of the operation unit 20 through the bus 26.

Step S6 is a step of turning the CML of NCU 2 off through the bus 26 to connect the line 2a to the telephone set 4.

Step S8 is a step of inputting operation information from the operation unit 20 through the bus 26 and determining whether the facsimile transmission is selected. When the facsimile transmission is selected, the flow goes to step S12. When the facsimile transmission is not selected, the flow goes to step S10.

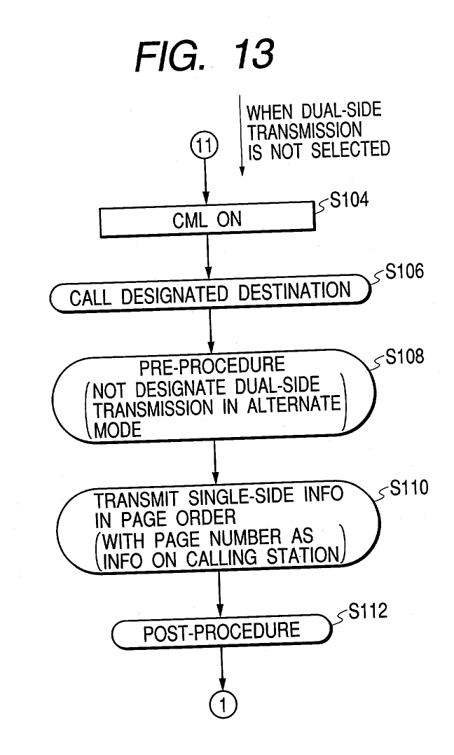

Step S12 is a step of inputting information from the operation unit 20 through the bus 26 and determining whether transmission of dual-side original is selected. When the transmission of dual-side original is selected, the flow proceeds to step S14. When the transmission of dual-side original is not selected, the flow proceeds to step S104 of FIG. 13.

Step S14 is a step of initializing a read sheet counter K (for counting the numbers of read sheets) and a side flag to “1” and “front,” respectively. These counter and flag shall be reserved in predetermined areas of the memory circuit 18 (the same will also apply to a page counter and a transmit sheet counter L described hereinafter). The side flag can get the value “front” or “back” and in practice, for example, digits like “0” and “1” are set to the memory.

Step S18 is a step of reading image information of the original side indicated by the read sheet counter K and the side flag, by the reading circuit 14 and storing the read information in an image memory area of the memory circuit 18.

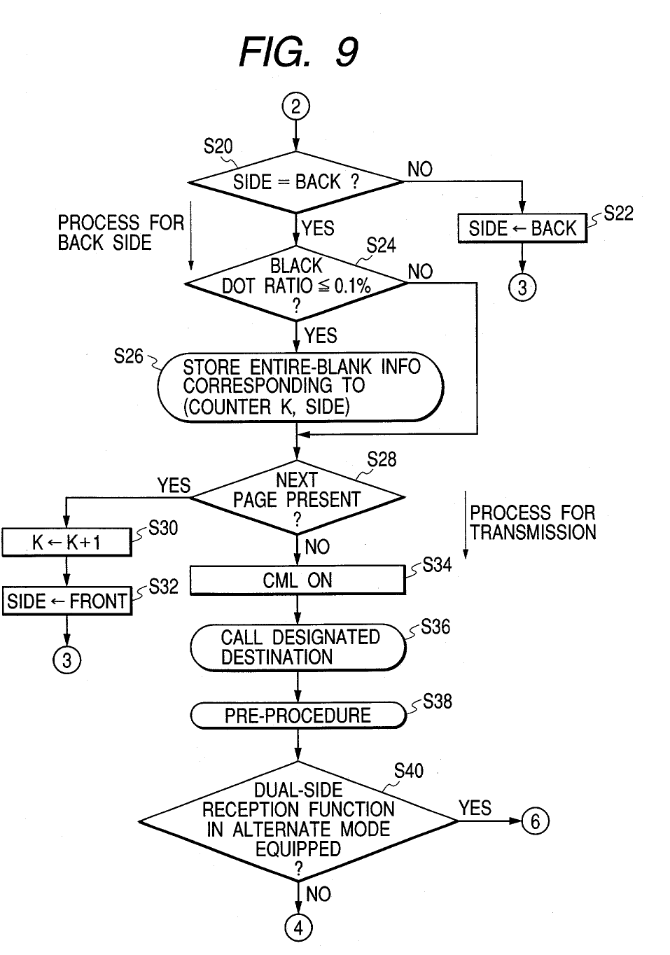

Step S20 in FIG. 9 is a step of determining whether the value of the side flag is “back.” If the value of the side flag is not “back” then the flow transfers to step S22; if the value of the side flag is “back” the flow transfers to step S24.

Step S22 is a step of setting the side flag to “back” and looping back to step S18 of FIG. 8.

Step S24 is a step of determining whether the original image read at step S18 is (almost) entire-blank. This can be implemented, for example, by determining whether the percentage of black dots occupying the original image is not more than 0.1% (this reference value may be freely determined by those skilled in the art). When step S24 ends in yes, the flow proceeds to step S26. When step S24 ends in no, the flow goes to step S28.

Step S26 is a step of storing information indicating that the side is entire-blank information, in a predetermined storage area for storage of a state (whether entire-blank or not) of that side corresponding to the read sheet counter K and the side flag.

Step S28 is a step of determining whether the next page to be read by the reading circuit 14 is present. When the next page is present, the flow moves to step S30. When the next page is absent, the flow proceeds to step S34.

Step S30 is a step of incrementing the read sheet counter K by one and step S32 a step of setting the side flag to “front” and looping back to step S18 to move into processing of the front side of the next original.

After all the originals have been read, the flow proceeds to step S34 to turn the CML of NCU 2 on through the bus 26 to connect the line 2a to the end of the facsimile apparatus (hybrid circuit 6).

Step S36 is a step of controlling the calling circuit 10 through the bus 26 to dial the designated destination. The destination shall be designated through the ten keys, one-touch button dialing keys, etc. of the operation unit 20.

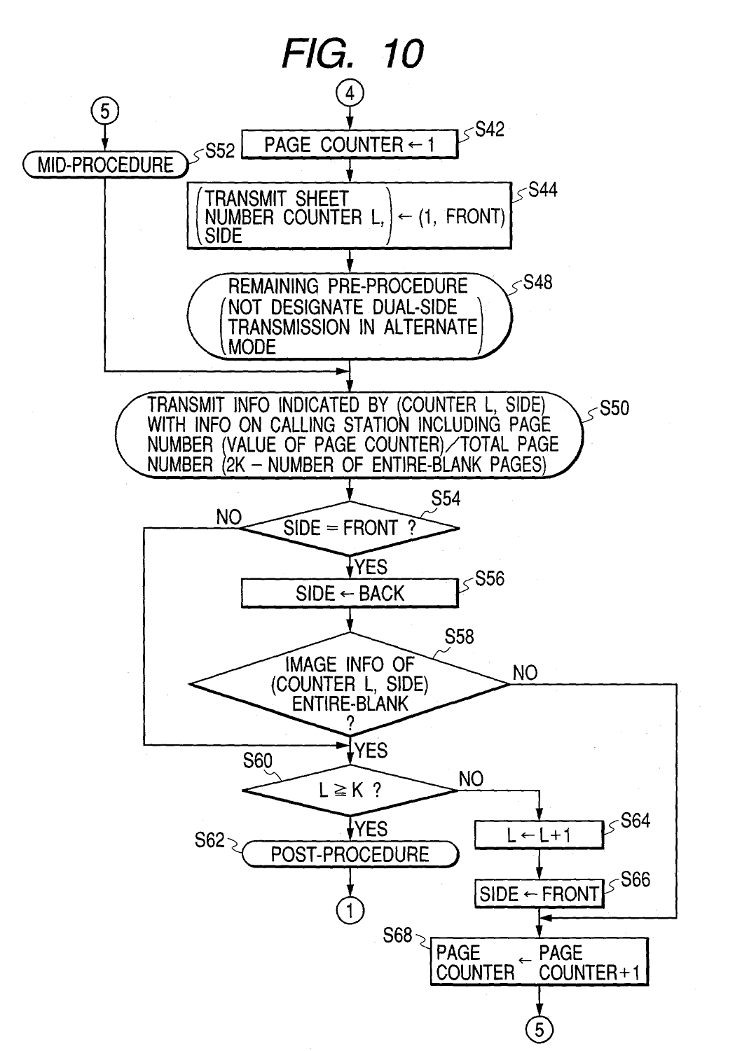

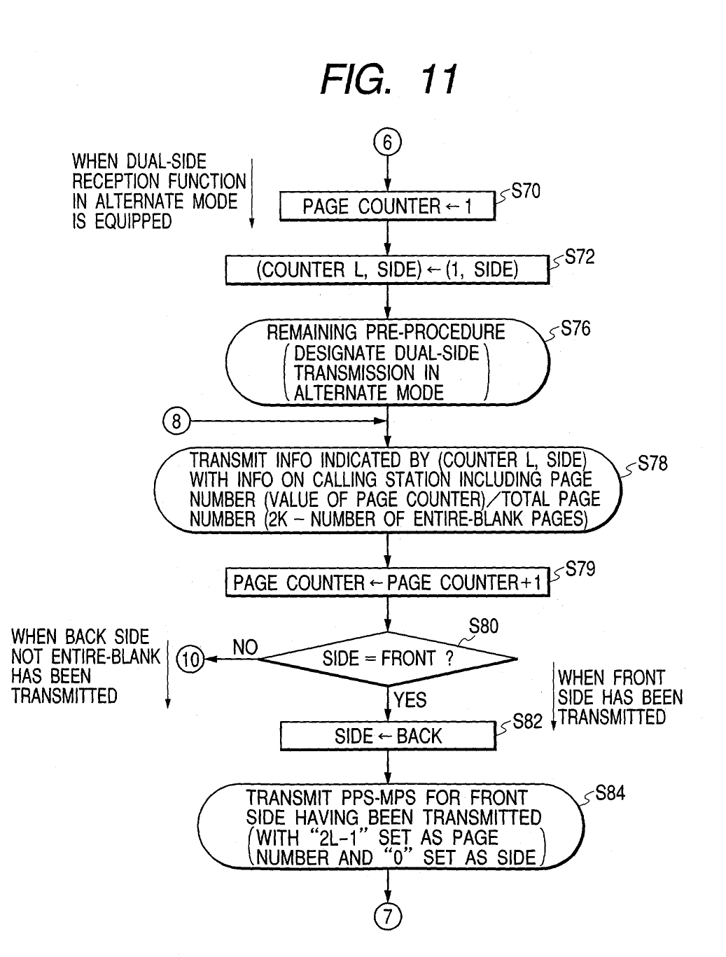

Step S38 is a step of executing facsimile pre-procedure and step S40 is a step of determining whether the correspondent receiver supports the dual-side receiving function in the alternate mode. This determination can be made by checking the bit X of FIF of the DIS signal received from the receiver. When the receiver is equipped with the dual-side receiving function in the alternate mode, the flow transfers to step S70 of FIG. 11. When the receiver is not equipped with the dual-side receiving function in the alternate mode, the flow transfers to step S42 of FIG. 10.

When the receiver is not equipped with the dual-side receiving function in the alternate mode, the flow goes to step S42 of FIG. 10 to set “1” in a page counter (an internal counter different from the page counter PC of ECM). This page counter is a counter which counts the page number included in the originator information.

Step S44 is a step of setting “1” and “front” in a transmit sheet counter L (for counting the number of sheets to be transmitted) and a side flag.

Step S48 is a step of executing remaining facsimile pre-procedure. At this step, the dual-side procedure (in the alternate mode) is not designated (i.e., communication is performed using only the conventional single-side procedure).

Step S50 is a step of reading the image information indicated by the current transmit sheet counter L and the side flag, out of the image memory area of the memory circuit 18 and transmitting it. At this time, the originator information is added to the image data so as to record the communication date & time, the originator's identification number (telephone number, mail address, or the like), the originator's name (or an arbitrary character string defined by the user, or the like), etc., in addition to the page number, at the header part or the like by the use of the character generator or the like, and the page number is expressed in the form of “page number/total page number” (cf. FIG. 14). Among these, the “page number” is generated from the value of the page counter and the “total page number” from the value of (2K—the number of entire-blank pages).

Step S54 is a step of determining whether the value of the side flag is “front.” When the value of the side flag is “front,” the flow moves to step S56. When the value of the side flag is not “front,” the flow moves to step S60.

When the value of the side flag is “front,” the flow goes to step S56 to set “back” in the side flag and then to step S58 to check whether the image information indicated by the transmit sheet counter L and the side flag is entire-blank, i.e., whether the back side corresponding to the front side just transmitted is entire-blank. When step S58 ends in yes, the flow moves to step S60. When step S58 ends in no, the flow moves to step S68.

When the value of the side flag is not “front” at step S54, i.e., when the back side was handled heretofore, the flow directly transfers to step S60 to determine whether the value of the transmit sheet counter L is not less than the read sheet counter K, i.e., whether all the images read and stored in the memory have been transmitted. When step S60 ends in yes, the flow goes to step S62. When step S60 ends in no, the flow goes to step S64. Step S62 is a step of executing facsimile post-procedure and thereafter the flow returns to step S6 of FIG. 8.

When there is a remaining image to be transmitted on the other hand, the flow goes to step S64 to increment the transmit sheet counter L by one. Step S66 thereafter is a step of setting “front” in the side flag and step S68 a step of incrementing the page counter by one. Then the flow loops back to step S52. Step S52 is a step of executing mid-procedure and thereafter the flow proceeds to step S50.

Namely, according to the configuration of steps S58, S60, and S64, when after completion of transmission of the front side the back side thereof is entire-blank, the transmit sheet counter L is counted up at step S64, as in the case where the transmission of the back side is detected at step S54, and the next front side is transmitted at step S50 thereafter. When after completion of transmission of the front side the back side thereof is not entire-blank, the flow goes from step S58 to step S68 to transmit the back side at next step S50.

As described above, when the receiver is not equipped with the dual-side receiving function in the alternate mode, only the images of pages except for entire-blank pages are transmitted using only the conventional single-side procedure according to the procedure of FIG. 10. The entire-blank image data is not transmitted and the page number of the originator information is counted up corresponding to each transmitted page that is not entire-blank.

When the receiver is equipped with the dual-side receiving function in the alternate mode on the other hand, the flow transfers to step S70 of FIG. 11. This step S70 is a step of first setting “1” in the page counter.

Subsequent step S72 is a step of setting “1” and “front” in the transmit sheet counter L and the side flag.

Step S76 is a step of executing remaining facsimile pre-procedure to designate the dual-side procedure in the alternate mode by the bit X and the bit (X+1) of the DCS signal.

Step S78 is a step of reading the image information indicated by the transmit sheet counter L and the side flag, out of the image memory area of the memory circuit 18 and transmitting it. At this time, the originator information is generated as at step S50. Namely, the page number of the originator information is expressed in the form like “page number/total page number” (cf. FIG. 14) by generating the “page number” from the value of the page counter and generating the “total page number” from the value of (2K—the number of entire-blank pages).

Step S79 is a step of incrementing the page counter by one.

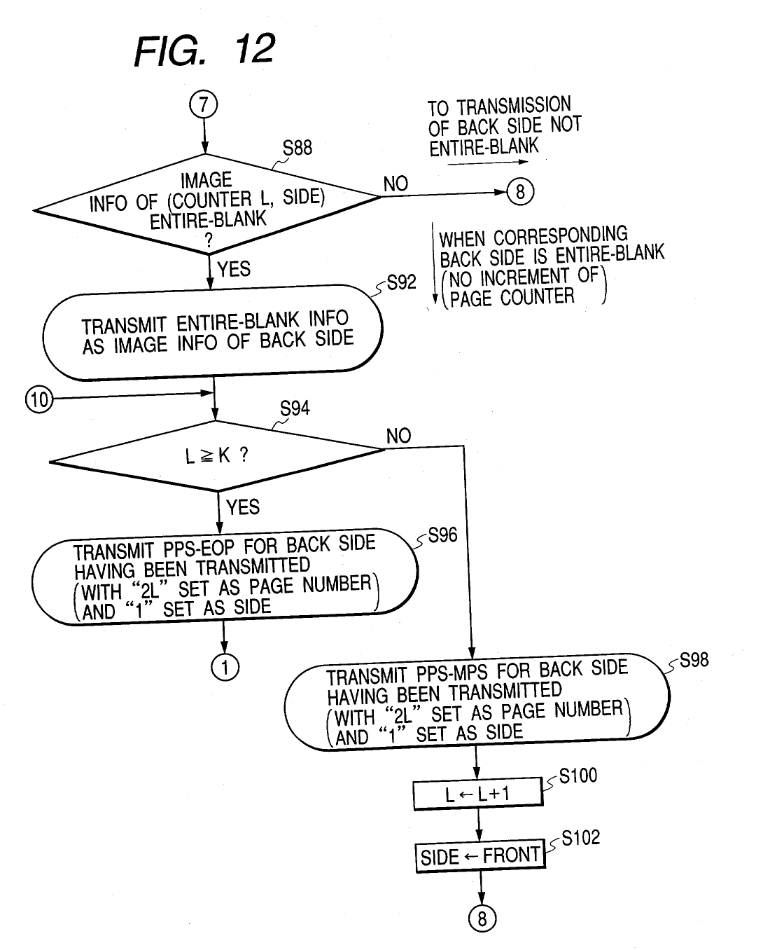

Step S80 is a step of determining whether the value of the side flag is “front.” When the value of the side flag is “front”, the flow goes to step S82. When the value of the side flag is not “front,” the flow goes to step S94 of FIG. 12.

When the value of the side flag is “front,” “back” is set in the side flag at step S82. Subsequent step S84 is a step of transmitting the PPS-MPS signal corresponding to the front side just transmitted. In this case, the value of (2L−1) is transmitted as Page Number (PN). The value of front/back of Page Information is set to “0” indicating the front side. After that, the processing moves to step S88 of FIG. 12.

Step S88 of FIG. 12 is a step of checking whether the image information indicated by the transmit sheet counter L and the side flag is entire-blank. Namely, it is determined whether the back side corresponding to the front side just transmitted is entire-blank. When step S88 ends in yes, the flow goes to step S92. When step S88 ends in no, the flow loops back to step S78 of FIG. 11 to transmit the information of this back side.

When at step S88 the back side corresponding to the front side just transmitted is entire-blank, the entire-blank information is transmitted at step S92 and then the flow goes to step S94. Namely, for the entire-blank back side, this step S92 is executed instead of aforementioned step S78 (image transmission of non-entire-blank image) and step S79 (increment of the page counter), and then the flow goes to step S94.

On the other hand, when the value of the side flag is not “front” at step S80 (or after the back side being not entire-blank has been transmitted) or when the flow passes through foregoing step S92 (or after the entire-blank back side has been transmitted), it is determined at step S94 whether the value of the transmit sheet counter L is not less than the read sheet counter K, i.e., whether all the images read and stored in the memory have been transmitted. When step S94 ends in yes, the flow goes to step S96. When step S94 ends in no, the flow goes to step S98.

When it is determined at step S94 that all the images read and stored in the memory have been transmitted, the flow goes to step S96 to transmit the PPS-EOP signal corresponding to the image information of the back side just transmitted. At this step, the value of (2L) is transmitted as Page Number (PN). The value of front/back of Page Information is set to “1” indicating the back side. After that, the processing returns to step S6 of FIG. 8.

When there remains an original image to be transmitted at step S94 on the other hand, the flow goes to step S98 to transmit the PPS-MPS signal corresponding to the entire-blank back side just transmitted. At this step, the value of (2L) is transmitted as Page Number (PN), as at step S96. The value of front/back of Page Information is set to “1” indicating the back side.

Step S100 is a step of incrementing the transmit sheet counter L by one in order to transfer to the processing of the image of the next page. Step S102 is a step of setting “front” in the side flag, and then the flow goes to step S78 of FIG. 11.

As described above, when the receiver is equipped with the dual-side receiving function in the alternate mode, the dual-side transmission in the alternate mode is carried out according to the procedure of FIGS. 11 and 12. At this time, the entire-blank image data is transmitted for the entire-blank pages (only the entire-blank back sides in the present embodiment) and the page number of the originator information is counted up corresponding to each page being not entire-blank.

When the transmission of dual-side original is not selected at step S12 of FIG. 8 on the other hand, the CML of NCU 2 is turned on through the bus 26 at step S104 of FIG. 13 to connect the line 2a to the end of the facsimile apparatus (hybrid circuit 6).

Step S106 is a step of controlling the calling circuit 10 to dial the designated destination. The destination is designated through the ten keys, one-touch dialing keys, etc. of the operation unit 20.

At step S108 the facsimile pre-procedure is executed and use of the conventional single-side procedure is declared herein without designating the dual-side transmission (in the alternate mode) by the DCS signal.

Step S110 is a step of transmitting the single-side information in the page order. Namely, this step is a step of carrying out the processing of reading images on the front sides of originals by the reading circuit 14 and transmitting the images in the page order. At this step, the page number is counted up at every reading of an image on a front side of an original and the page number is transmitted as included in the image of the originator information.

Step S112 is a step of executing the facsimile post-procedure and then the flow returns to step S6 of FIG. 8.

As described above, where the dual-side transmission is not designated, the images on the front sides of originals are transmitted using the conventional single-side procedure, according to the procedure of FIG. 13. It is conceivable herein that the originator information is also transmitted for each entire-blank front side, as in the case of the conventional single-side procedure, but it is also possible to perform such control as not to add the originator information to each entire-blank page according to the procedure similar to FIG. 10.

As is clear from the above, the present embodiment is arranged so that when a certain side of an original (a back side in the above control example) is entire-blank, the entire-blank information of the back side is transmitted as specified in ITU-T Recommendation T.30 and in that case, the page number (PN described above) and the identification information of front/back (SIDE described above) specified in the ITU-T Recommendation are also transmitted according to I-TUT Recommendation T.30. Therefore, the present embodiment does not have to use any special dual-side communication procedure, thus providing high compatibility of communication, preventing the transmitter from becoming uncommunicable with any receiver supporting ITU-T Recommendation T.30, and permitting secure dual-side communication.

Since the control is such that, when the entire-blank information is transmitted as image information of a certain original side (a back side in the above control example), the originator information (header information) is not recorded for that side on the receiver end, it is feasible to record the natural originator information without making an odd impression on the receiving user.

As for the page number recorded as the originator information. on the receiver end, the page number is counted up with effective image information being not entire-blank, but is not with the entire-blank image information. In other words, the originator information with page numbers of serial numbers is generated for only the effective image information being not entire-blank and in this sense, therefore, it is also feasible to avoid making the odd impression on the receiving user.

The above described the control example in the alternate mode, and it should be noted herein that the features of the present invention are the following two points: the originator information is not added in the case of an entire-blank side though the entire-blank side is transmitted as it is; and the page number recorded as the originator information on the receiver end is counted up with each effective image information being not entire-blank, but is not counted up with each entire-blank image information; and it is needless to mention that such control can be executed not only in the alternate mode but also in the continuous mode.

The above described the configuration wherein the (almost) entire-blank state of the back side was detected and the originator information was not added for the entire-blank back side, but the same control can also be applied to the front side. Namely, it is also possible to carry out, not only for the back side but also for the front side, the control of transmitting the entire-blank side as it is and adding no originator information to the entire-blank side information, and the control of counting up the page number recorded as the originator information on the receiver end, with each effective image information being not entire-blank but not counting up the page number with each entire-blank image information.

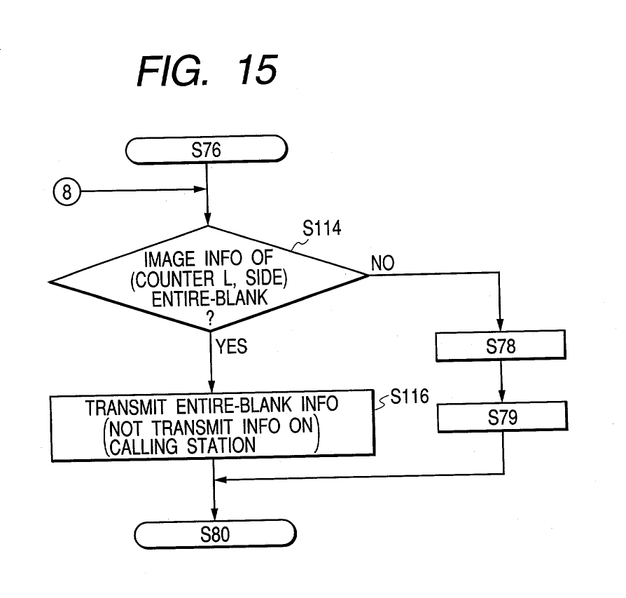

For example, as shown in FIG. 15, a step S114 of carrying out the same processing as step S88 (FIG. 12) is placed before the steps S78 and S79 of FIG. 11. Then step S116 of carrying out the same processing as step S92 (FIG. 12) is executed with the result of determination at step S114 being entire-blank, while the steps S78 and S79 are executed with the determination at step S114 being not entire-blank. The determination about whether the front side is entire-blank can be made by executing the same processing as S24 and S26 between no at S20 and S22 in FIG. 9.

Which information should be transmitted on the occasion of detection of an (almost) entire-blank original side can be freely determined between data of a complete entire-blank page generated (or preliminarily prepared) and data of an actual (almost) entire-blank image read by the reading circuit 14.

The above described the example wherein the originator information was generated as image information on the transmitter side and transmitted, but it is also possible to employ a configuration wherein the originator information and the value of the page counter (serial page number) included therein can be transmitted in any form other than the form of image data (e.g., they can be transmitted using the FIF of a specific facsimile procedure signal or the like) and wherein the data is converted into an image and the image is recorded on the receiver end.

The above described the configuration of the facsimile-only machine, but it is needless to mention that the present invention can also be applied to facsimile apparatus of other forms, in addition to the facsimile-only machines. For example, the present invention can also be applied to a configuration wherein a FAX modem is externally or internally mounted on a general-purpose terminal such as a personal computer to execute the facsimile communication under software control. In that case, the control programs of the present invention can be stored in and supplied from any computer-readable storage medium such as a hard disk, a floppy disk, an optical disk, a magnetooptical disk, or a memory card, as well as the aforementioned ROM 24. It is a matter of course that the present invention can also be applied to so-called digital multifunction machines in which an image forming apparatus is equipped with a FAX communication interface and/or a network interface.

As is clear from the above description, the facsimile apparatus for transmitting the dual-side image information, the control method thereof, and the control program thereof according to the present invention employ the configuration wherein whether the image information of the front side or the back side of the original to be transmitted is entire-blank image information being almost entire-blank is detected and wherein the control is made so that when the entire-blank image information is detected, the entire-blank image information is transmitted without adding the image information of the corresponding originator information to the entire-blank image information, and, therefore, the present invention provides the excellent effect that it is feasible to prevent the degradation of compatibility of communication, by the transmission of the entire-blank image information about the entire-blank side, and to record the natural originator information without making the odd impression on the receiving user, by the control to transmit the entire-blank image information without adding the image information of the corresponding originator information thereto.

What is claimed is:

1. A facsimile apparatus for transmitting dual-side image information, comprising:
detecting means for detecting whether image information of a front side or a back side of an original to be transmitted is entire-blank image information being almost entire-blank; and
control means for performing such control that, when said detecting means detects the entire-blank image information, the entire-blank image information is transmitted, without adding image information of corresponding originator information to the entire-blank image information.

2. The facsimile apparatus according to claim 1, wherein a page number included in said originator information is not counted up with the entire-blank image information, but is counted up with effective image information being not entire-blank, which is transmitted together with originator information.

3. The facsimile apparatus according to claim 1, wherein, for both the entire-blank image information and effective image information being not entire-blank, a page number and a front/back identification information piece are transmitted by a post-message signal, based on ITU-T Recommendation T.30.

4. The facsimile apparatus according to claim 1, wherein control is performed so as to transmit effective image information being not entire-blank, with corresponding originator information added thereto.

5. The facsimile apparatus according to claim 1, wherein said detecting means detects, for only the back side of the original, whether image information is entire-blank image information being almost entire-blank.

6. The facsimile apparatus according to claim 1, wherein said detecting means performs the detection of the entire-blank image information for both the front side and the back side of the original, and said control means adds the originator information to neither the entire-blank image information of the front side nor the entire-blank image information of the back side.

7. A control method for a facsimile apparatus capable of transmitting dual-side image information, comprising the steps of:
detecting whether image information of a front side or a back side of an original to be transmitted is entire-blank image information being almost entire-blank; and
performing such control that, when said detecting step detects the entire-blank image information, the entire-blank image information is transmitted, without adding image information of corresponding originator information to the entire-blank image information.

8. A storage medium storing a program for executing a control method for a facsimile apparatus capable of transmitting dual-side image information, said control method comprising the steps of:
detecting means for detecting whether image information of a front side or a back side of an original to be transmitted is entire-blank image information being almost entire-blank; and
performing such control that, when said detecting step detects the entire-blank image information, the entire-blank image information is transmitted, without adding image information of corresponding originator information to the entire-blank image information.
